(19) United States
(12) Patent Application Publication
(10) Pub. No.: US 2015/0379408 A1
(43) Pub. Date: Dec. 31, 2015

(54) Using Sensor Information for Inferring and Forecasting Large-Scale Phenomena

(71) Applicant: Microsoft Corporation, Redmond, WA (US)

(72) Inventors: Ashish Kapoor, Kirkland, WA (US); Eric Horvitz, Kirkland, WA (US)

(21) Appl. No.: 14/320,089

(22) Filed: Jun. 30, 2014

(51) Int. Cl. G06N 5/04

(52) U.S. Cl. CPC G06N 5/04

(57) ABSTRACT

Various techniques for inference and prediction about large-scale phenomena from sensors are described herein. A system includes a processor to execute processor executable code, wherein the processor executable code, when executed by the processor, causes the processor to combine sensor data from a plurality of sensors embedded in moving objects. The code causes the processor to process the combined data using a spatial statistics model. The code also enables the processor to infer an unobserved condition or to predict a future condition based on the processed data.

### BACKGROUND

Various sensor networks are distributed around the world. For example, the National Oceanic and Atmospheric Administration (NOAA) has a network of balloons that can sense wind speed and direction at different altitudes at specific points throughout the United States. These high-altitude balloons are lofted twice a day and measure winds from mean sea level to about 53,000 feet. The wind information from 176 wind stations is accessible through the NOAA Winds Aloft program. The wind information can be in the form of coarse wind maps. The maps are typically produced by averaging the measured wind speeds and directions between NOAA wind stations.

In addition, various moving objects with sensors are also distributed globally. For example, the development of air travel has produced fleets of thousands of aircraft that are airborne globally at any particular point in time. For each flight, a flight plan is typically filed with a corresponding governmental agency. For example, the Federal Aviation Administration (FAA) receives flight plans for airplanes traveling over the United States. Any deviation from a flight plan is also generally reported to the FAA.

### SUMMARY

The following presents a simplified summary of the innovation in order to provide a basic understanding of some aspects described herein. This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

An implementation provides a system for prediction. The system includes a processor to execute processor executable code. The processor executable code, when executed by the processor, causes the processor to combine sensor data from a plurality of sensors embedded in moving objects. The code also causes the processor to process the combined data using a spatial statistics model. The code also directs the processor to predict a future condition based on the processed data.

Another implementation provides a method for processing sensor data from a plurality of moving objects. The method includes receiving the sensor data from the plurality of moving objects. The method also includes combining the sensor. The method includes processing the combined data using a spatial statistics model. Processing the combined data includes calculating a value for missing information based on the combined data.

Another implementation provides one or more computer-readable storage media for analysis of sensor data. The computer-readable storage media include instructions that, when executed by a processor, cause the processor to detect access data that indicates a cost of collecting sensor data from a plurality of moving objects. The computer-readable storage media also include instructions that cause the processor to request the sensor data from a subset of the plurality of moving objects based on the access data. The computer-readable storage media also include instructions that cause the processor to combine the sensor data with data from a stationary network. The computer-readable storage media also include instructions that cause the processor to process the combined data using a spatial statistics model. The computer-readable storage media also include instructions that cause the processor to predict a future condition based on the processed data.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an example system for prediction;

FIG. 2 is an example probabilistic graphical model for wind prediction;

FIG. 3 is a diagram of an example wind triangle;

FIG. 4 is a diagram of two wind triangles sharing the same wind vector;

FIGS. 5A-5C are diagrams of wind vector maps;

FIG. 6 is a diagram of a map depicting a predicted balloon path, according to implementations described herein;

FIG. 7 is a diagram of data for flying aircraft over the continental US with three alternate routes for an aircraft flying from San Francisco (SFO) to Baltimore (BWI);

FIG. 8 is a detailed process flow diagram of an example method for processing sensor data from a plurality of moving objects;

FIG. 9 is a block diagram showing a tangible, computer-readable storage media for analysis of sensor data.

### DETAILED DESCRIPTION

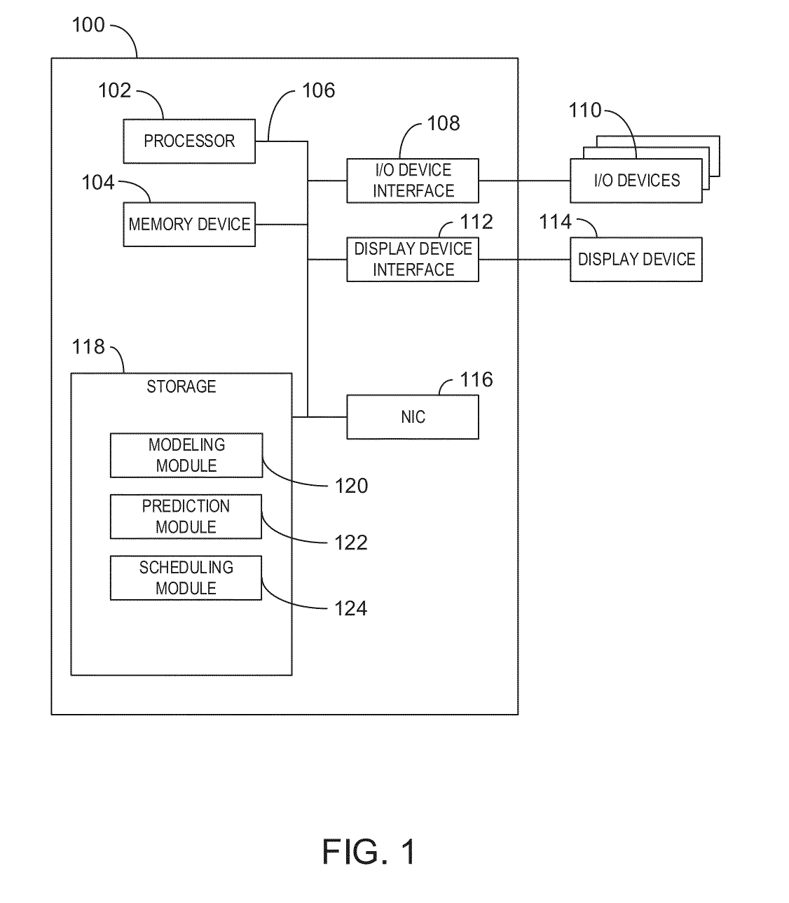

As a preliminary matter, some of the Figures describe concepts in the context of one or more structural components, variously referred to as functionality, modules, features, elements, or the like. The various components shown in the Figures can be implemented in any manner, such as software, hardware, firmware, or combinations thereof. In some implementations, various components reflect the use of corresponding components in an actual implementation. In other implementations, any single component illustrated in the Figures may be implemented by a number of actual components. The depiction of any two or more separate components in the Figures may reflect different functions performed by a single actual component. FIG. 1, discussed below, provides details regarding one system that may be used to implement the functions shown in the Figures.

Other Figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. Computer-readable storage media, as used herein, do not include propagating signals. In contrast, computer-readable media, i.e., not storage media, may include communication media such as transmission media for wireless signals and the like.

As mentioned above, existing networks that collect wind information, for example, produce course wind maps. Although course wind data may suffice for airplanes that can be set to fly at certain speeds in largely fixed routes under the assumption that drag is a main cost factor, a finer grained model is better for other applications. For example, applications such as turbulence prediction or flying with the wind to save on gas and time can make use of greater wind model detail. In addition, potential applications include weather modeling, storm-path prediction, hurricane and tornado modeling, among others. A detailed model would be also useful in other fluid applications such as measuring and modeling currents in the oceans.

According to implementations described herein, a future condition may be calculated based on a statistical model that can infer the current status of phenomena as well as predict the future status using data from sensors embedded in moving objects as well as in a stationary network. A stationary network, as used herein, includes any suitable support structure or station that collects data at a fixed geographical location. For example, a stationary network may include wind stations, air traffic control systems, and oceanic buoys, among others. The stationary networks can collect data that includes any suitable environmental data from a fixed geographical location. For example, the data from a stationary network can indicate a wind speed, wind direction, or ocean current, among others. A moving object, as used herein, includes any suitable aircraft such as a rotorcraft, a jet aircraft, a propeller aircraft, or a drone, among others, or any suitable watercraft. The sensor data from the sensors embedded in the moving objects, along with the data collected from the stationary network, can be analyzed and modeled to form predictions about future conditions at geographical locations. A future condition, as referred to herein, can include any suitable information, such as wind speed and wind direction, among others, that corresponds to a location. In some examples, a future condition can be predicted based on data from flight tracking websites such as actual observed groundspeeds of airplanes in addition to their intended airspeeds. As used herein, airspeed refers to the fixed cruising velocity of an aircraft relative to the air mass through which the aircraft is flying. The wind conditions at a location can thus be inferred or calculated from the aircraft data along with data from a stationary network from other locations. In some implementations, predicting the future conditions may enable aircraft to fly with the wind, which can reduce travel time and increase fuel efficiency. The improved use of wind can also result in overall reduced carbon emissions. Moreover, this increased efficiency comes without the costs of additional expensive hardware as the future conditions are calculated based on available data from existing stationary networks and sensors embedded in existing moving objects.

In implementations, the accuracy of the future condition can also be assessed and additional sensor data can be collected to increase the accuracy of the future condition. In some examples, an expected value of information (VOI) can be calculated, wherein the VOI indicates whether additional sensor data from particular single moving objects or sets of moving objects and data from stationary networks are to be requested based on the accuracy of the future condition. For example, the VOI can indicate the frequency at which sensor data from a geographic location is to be collected. In some examples, sensor data from a flight path may have a low VOI if multiple aircraft collect sensor data along the flight path at a high frequency. In some implementations, expected VOI computations can be used to request that certain moving objects are re-rerouted, such as shifting the flightplans of aircraft, so that they move along routes that increase the VOI of the collected sensor data used for inferences of current or future conditions. By increasing the sensor data available to the prediction model, the future conditions may become more accurate and may result in an improved use of winds by other aircraft.

In some implementations, the VOI can also be considered along with a cost associated with collecting additional sensor data. For example, while flight information is publicly available, there may still be a significant cost associated with collecting sensor data from an aircraft. Based on the cost to collect sensor data from an aircraft, a system can determine a subset of aircraft that are to collect sensor data in order to predict a future condition with an acceptable accuracy at a reduced cost. In some examples, the cost of rerouting an airplane to collect additional sensor data may be acceptable in order to increase the accuracy of the predicted future conditions and improve the efficiency of other flight routes.

In some implementations, the VOI can also be considered along with a cost associated with collecting additional sensor data, using a weighting that considers the value of increasing certainty in inferences about current or future forecasts about the large-scale phenomena based on numbers of moving objects (e.g., airplanes) in different regions and/or the number and priority of moving objects in the regions or expected in the regions in the future.

FIG. 1 is a block diagram of an example of a computing system for prediction. The computing system 100 may be, for example, a personal mobile device, laptop computer, desktop computer, tablet computer, computer server, flight management computer, or a node in a computing cloud, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory, read-only memory, flash memory, or any other suitable memory systems. The instructions that are executed by the processor 102 may be used to predict future conditions from sensor information. In some implementations, the instructions may be used to request sensor data from a subset of moving objects and/or stationary networks. For example, the instructions may be used to request information from a plurality of aircraft. In some implementations, the instructions may be used to route the aircraft. For example, an aircraft may be rerouted from an original flight path to increase the amount of sensor data for a geographic location.

The processor 102 may be connected through a system bus 106 (e.g., PCI®, PCI-Express®, etc.) to an input/output (I/O) device interface 108 adapted to connect the computing system 100 to one or more I/O devices 110. The I/O devices 110 may include, for example, a keyboard, a gesture recognition input device, a voice recognition device, and a pointing device, wherein the pointing device may include a touchpad or a touchscreen, among others. The I/O devices 110 may be built-in components of the computing system 100, or may be devices that are externally connected to the computing system 100.

The processor 102 may also be linked through the system bus 106 to a display device interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100. A network interface card (NIC) 116 may also be adapted to connect the computing system 100 through the system bus 106 to a network (not depicted). For example, a computer 100 may receive updated information from a variety of moving objects and/or stationary networks through the network.

The storage 118 can include a hard drive, an optical drive, a USB flash drive, an array of drives, or any combinations thereof. The storage 118 may include a modeling module 120, a prediction module 122, and a scheduling module 124. In implementations, the modeling module 120 combines sensor data from various sources to form a model. In some implementations, the modeling module 120 can perform machine learning to build a model for a network of sensors. For example, the modeling module 120 may determine that a kernel function captures the similarity among stationary network sites by increasing model evidence until a threshold is reached. As used herein, model evidence refers numeric quantity that signifies how well the model and the parameters associated with the model fit the observed data. For example, the kernel function may be represented as a linear combination of geography-based similarity functions. In some implementations, the prediction module 122 may determine a set of moving objects and/or stationary networks to query given costs associated with querying the moving objects and/or stationary networks. For example, querying an aircraft may cost a specific amount of money per query. Thus, given a budget and forecast accuracy, the prediction module 122 may determine a subset of aircraft to query. The scheduling module 124 can analyze a system of moving objects and schedule routes to increase efficiency. For example, a scheduling module 124 may determine a flight path for an aircraft that uses the least energy or reduces the flight time. In some examples, the scheduling module 124 may take VOI into account when scheduling a flight path. For example, the amount of data available to predict future conditions in the system may be increased for a cost below a threshold or budget by rerouting the paths of any suitable number of moving objects.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional applications, additional modules, additional memory devices, additional network interfaces, etc.). Furthermore, any of the functionalities of the modeling module 120, the prediction module 122, and the scheduling module 124 can be partially, or entirely, implemented in hardware and/or in the processor 102. For example, the functionality can be implemented with an application specific integrated circuit, in logic implemented in the processor 102, or in any other device. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs), etc.

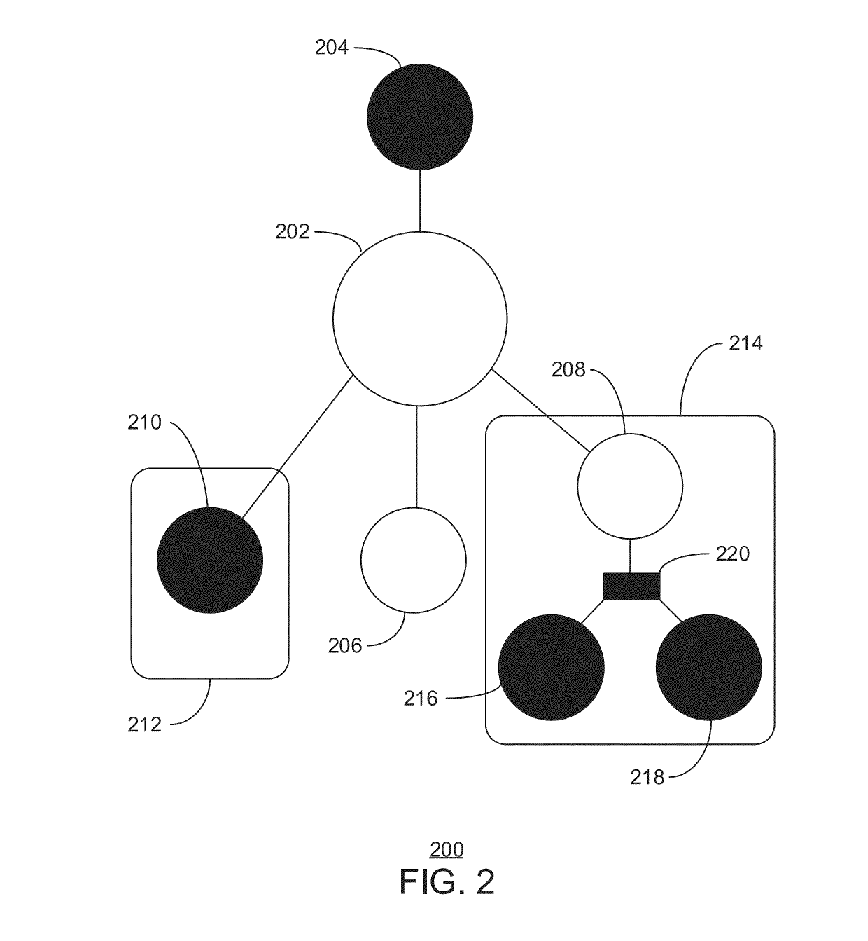

FIG. 2 is an example probabilistic graphical model for wind prediction. In FIG. 2, the unshaded circle representing unobserved true wind velocities 202 is connected by a line representing a probabilistic relationship to a shaded circle representing observed wind velocities at physical sites 204. True wind velocities 202 is also connected via a line representing an inference to another unshaded circle representing a prediction at a target position 206. True wind velocities 202 is also connected via lines representing probabilistic relationships to an unshaded circle representing latent aircraft wind observation 208 and to another shaded circle representing wind station observation 210. Wind station observation 210 is within oval 212 representing a plurality of wind station observations. Likewise, latent aircraft observation 208 is within an oval representing aircraft data 214. Also within aircraft data 214 are two shaded circles representing observed aircraft ground speed component vectors x 216 and y 218 of an aircraft. A black box representing a potential function P(t, v^{x}, v^{y}) 220 relates the latent aircraft wind observation 208 to observed aircraft ground velocity component x 216 and observed aircraft ground velocity component y 218. The wind prediction model of FIG. 2 is referred to generally by the reference number 200.

As mentioned above, the modeling module 120 combines observed data from the shaded circles 204, 212, 216, and 218, representing observed winds and other variables, to calculate true wind velocities 202. In implementations, data from sensors is processed through a spatial statistics model to infer a condition at a location and time. As used herein, a spatial statistics model can include support vector regression, least square regression, or Gaussian process modeling, and the like. For example, wind information from airplanes and wind stations can be combined to infer the wind at a time and place using a Gaussian process (GP) model. In some implementations, a kernel function is first determined to capture similarity between sites. A site, as used herein, includes a wind stations, airplanes, or any other sensor location. For example, the kernel function can be represented as a linear combination of simple geography-based similarity functions. In some examples, the similarity functions can be based on longitude, latitude, altitude, and time of observation at many different values of a scale parameter. For example, the scale parameter can be a threshold that smoothly makes the similarity zero as a distance between two points grows large. In some implementations, the system can generate the kernel function by determining a model that increases the accuracy of the predicted future condition above a threshold value. Evidence, as used herein, is a numerical quantity and signifies how well a model fits the given data. By comparing the evidence corresponding to different models, the system can choose a model most suitable for a task. In some examples, multiple kernel functions K¹, . . . , K^{k} are generated based on geographical variables. The multiple kernel functions are then combined linearly such that modeling module 120 determines that the resulting kernel function K can predict a future condition with an accuracy above a threshold value. Accordingly, kernel function K can be represented by the equation below, wherein a=a₁ . . . , aₖ) are weight parameters:

K=Σᵢ₌₁^{k}aᵢK⁽ⁱ⁾ Eq. (1)

The weight parameters can in turn be solved by evaluating the following objective function:

arg minₐ−logₐ(T_{L}|S) subject to: aᵢ≧0 for i ε{0, . . . , k}, Eq. (2)

wherein T_{L} represents data collected at wind stations, “a” represents a parameter, and S represents set of all aircraft and wind station locations. Once the parameters “a” are found, the modeling module 120 can use the resulting linear combination of kernels, K, for prediction.

Given a suitable kernel function, the modeling module 120 can generate inferences about conditions at a time and place. In implementations, the winds experienced at a target site 206 can be inferred by processing information from other sites and/or moving objects through a spatial statistics model. For example, the modeling module 120 can combine the NOAA data for wind station observations 212, site locations 204, and airplane data 216 and 218 to predict winds experienced at a target site 206. In some examples, the modeling module 120 can construct a probabilistic regression model to predict wind velocity under constraints of spatial smoothness. In some examples, the spatial statistics model used can be a Gaussian process (GP) model.

In some implementations, the modeling module 120 can impose a smoothness constraint via a Gaussian Process (GP) Prior. The GP Prior GP (W;S) assigns a higher probability of accuracy to the wind observations that respect similarity between the data points. In using the GP Prior, the modeling module 120 assumes that similar data points have the same wind. In some implementations, the similarity of data points can be determined using kernel function K from Eq. 1. Thus, the modeling module 120 imposes probabilistic constraints on the collection of true wind vectors 202 over the sites. The modeling module 120 can then use the previously discussed kernel function to represent the similarity of data points when applying the smoothness constraint.

In some implementations, the modeling module 120 can construct a Gaussian noise model to model the probabilistic relationships between observed winds 208, 210 and the true wind velocities 202. The noise model can account for minor deviations in airspeed data by adjusting the observed data. For example, such minor deviations may result from turbulence experienced by an airplane. The noise model can adjust the observed data for deviations due to the turbulence. Small deviations from filed air speeds by some planes are effectively reduced via sensing from large numbers of sensors. As the majority of planes follow their flight plans, the deviations of a few planes have little to no effect on the model An example noise model is given in Eq. 3, with target observation, t, true wind velocity, w, and noise model variance, d:

g(t,w)=(1/(\sqrt{2πd²})e^{-∥t-w∥}^{²}^{/2d}^{²} Eq. (3)

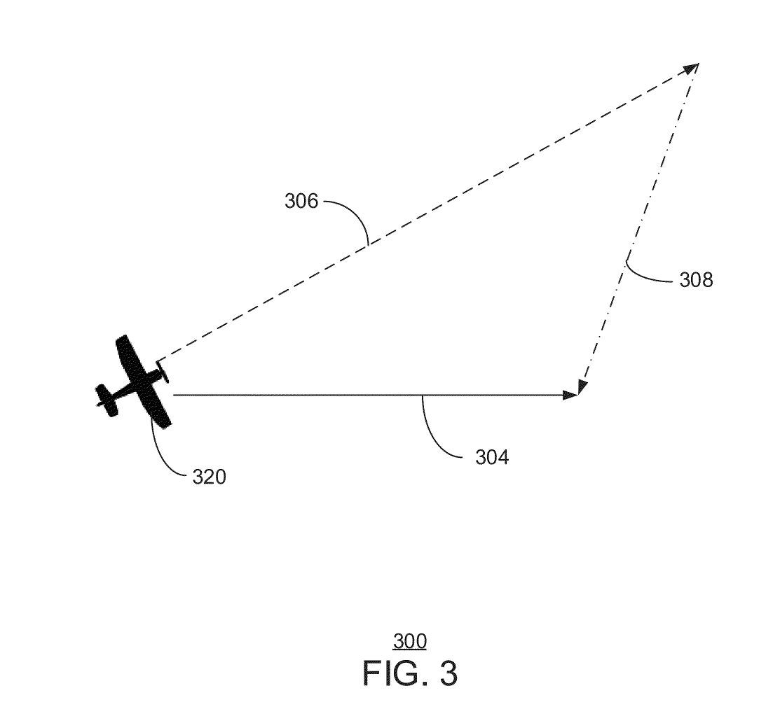

FIG. 3 is a diagram of an example wind triangle. Airplane 302 has a ground velocity vector indicated by arrow 304. Airplane 302 also has a heading and airspeed vector indicated by arrow 306. Another arrow connecting ground velocity vector 304 and air velocity vector represents wind velocity 308. The wind triangle of FIG. 3 is referred to generally by the reference number 300.

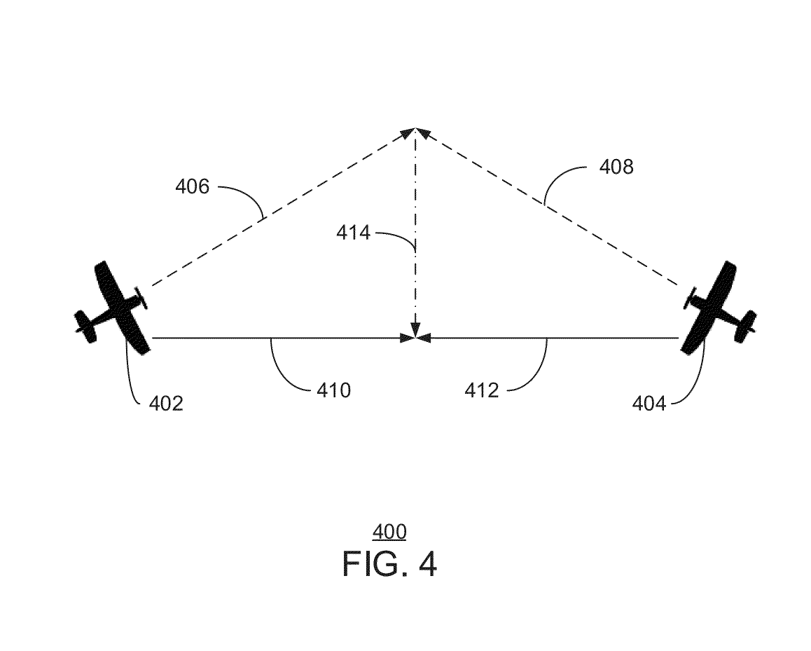

In the diagram of FIG. 3, a wind triangle is used to simplify the physics of determining wind speed from airspeed and observed ground velocity. Each of the vectors represented by arrows 304, 306, and 308, have a magnitude indicated by the length of the corresponding arrow and a direction indicated by the angle of each corresponding arrow. Using vector addition, the given magnitude and direction of a vector in a vector triangle can be calculated if at least two of the other vectors can be calculated. In some examples, however, one or more components of two vectors might be unknown. For example, the direction, or heading, of 306 may not be known in addition to unknown wind velocity 308. Therefore, wind velocity 308 may not be calculated using a single vector triangle and simple vector addition. More information can be requested to calculate wind velocity 308, as explained in FIG. 4 below.

FIG. 4 is a diagram of two wind triangles sharing the same wind vector 414. Airplane 402 and airplane 404 each have a heading and airspeed represented by respective arrows 406 and 408. Airplane 402 and airplane 404 also each have a ground velocity represented by arrows 410 and 412, respectively. The wind velocity vector 414 indicated by a down arrow bisects the triangle formed by arrows 406, 408, 410, and 412.

In the diagram of FIG. 4, wind velocity 414 is acting on both airplane 402 and airplane 404. Because the wind velocity 414 is a shared variable, the additional information about the velocity of the second plane 404 and its ground velocity 412 can be used to find the wind velocity 414 that is acting on both planes 402 and 404. Given the magnitude of vector 406, or airspeed “a,” the following relationship holds between observed velocity 410 and wind velocity 410:

(v^{x}−t^{x})²−(v^{y}−t^{y})²=∥a∥², Eq. (4)

wherein the x and y components denote projection of the vector on easterly and northerly headings, respectively, v denotes groundspeed velocity, and t denotes wind velocity.

In some examples, the following potential function can be induced that respects the above constraining property of Equation 4, given the magnitude of cruising airspeed ∥a∥:

ƒ(t,v^{x},v^{y})=e^{-B(∥v-t∥-∥a∥)}^{²}, Eq. (5)

wherein B is a fall-off parameter that causes a likelihood of the wind assignments to fall exponentially from an initial high likelihood as the winds begin to deviate from the above constraints. The potential function of Equation 5 assigns a high likelihood to the wind assignments t that respect the constraints of Equation 4. The likelihood of a set of parameter values given some observed outcomes is equal to the probability of those observed outcomes given those parameter values.

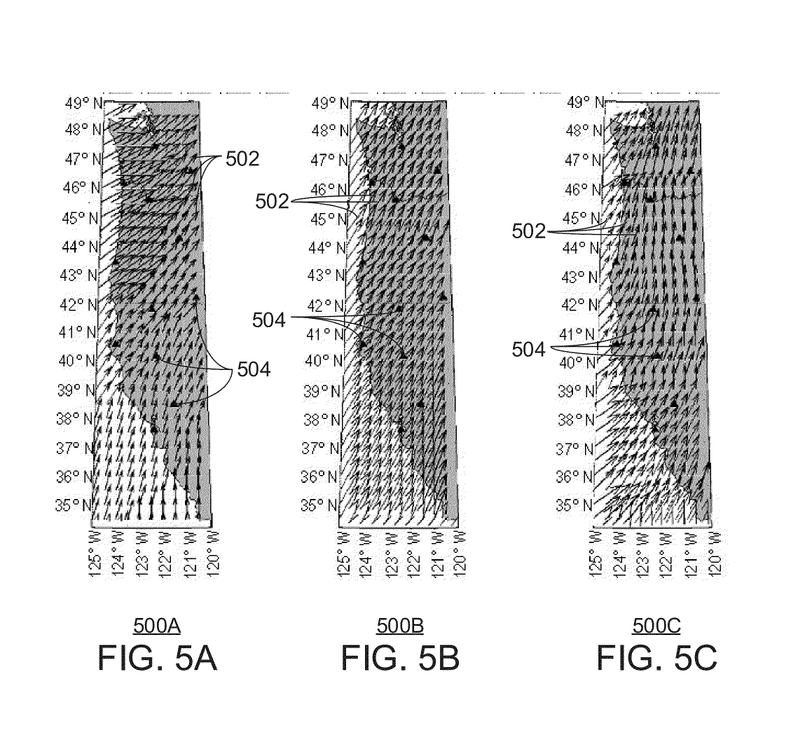

FIGS. 5A-5C are diagrams of wind vector maps. FIG. 5A is a diagram of a wind vector map based on the NOAA Winds Aloft forecast. FIG. 5B is a diagram of a wind vector map based on GPR Aloft data using Gaussian process estimation. FIG. 5C is a diagram of a wind vector map based on GPR Aloft combined with aircraft data, according to implementations described herein. Each diagram contains vector arrows 502 indicating the magnitude and direction of estimated winds at various locations. Each diagram also has black triangles 504 indicating ground-based NOAA wind stations.

In the diagram of FIG. 5A, a wind map was generated using NOAA Winds Aloft forecast information. In order to predict the winds at a latitude, longitude and altitude, the nearest Winds Aloft station was considered and linear interpolation was used to determine winds between the reported altitudes in the reports.

In the diagram of FIG. 5B, a wind map was generated using NOAA estimates by building a predictive model based on a Gaussian process. This model was based solely on the Winds Aloft data. The Winds Aloft data was processed using a Gaussian process model that allowed for non-linear interpolation across longitude, latitude, and altitude.

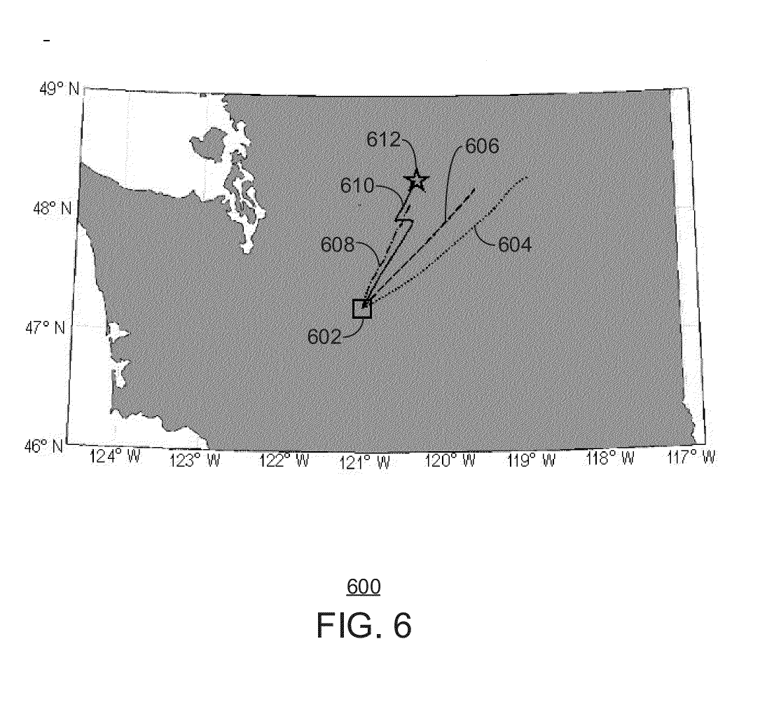

In the diagram of FIG. 5C, a wind map was also generated using a Gaussian process model. However, the model of FIG. 5C combines the GP Aloft data and aircraft data to produce a wind map according to the implementations described herein. The resulting vector map of FIG. 5C differs significantly from the map of FIGS. 5A and 5B. The differences in the vector wind paths and resulting accuracy of air flight path prediction are exemplified in FIG. 6 below.

FIG. 6 is a diagram of a map depicting a predicted balloon path, according to implementations described herein. The map shows the northwest portion of the state of Washington with corresponding latitudes and longitudes on the left and bottom sides of the map. Starting point 602 is indicated on the map by a square. Predicted paths 604, 606, and 608 are shown as dotted lines that begin at starting point 602. A fourth path, the path of ground truth of the high-altitude balloon 610, is also indicated by a solid line that begins at starting point 602 and ends at landing point 612 indicated by a star. As used herein, the ground truth refers to the actual observed path the balloon took as delineated on the ground directly beneath the balloon.

In the diagram of FIG. 6, three predicted paths 604, 606, and 608, were calculated based on different prediction models. Predicated path 604 was based on NOAA Winds Aloft forecast information, predicted path 606 was based on a predictive model using Gaussian processes on the Winds Aloft data, and predicted path 608 used both the aircraft data and Winds Aloft forecast data in its Gaussian process model. In predicting the path of the balloon for each of the paths, a balloon ascent profile was used to model the vertical velocity of the balloon at any specific altitude. As winds change with altitude, the ascent profile allowed the predictive models to take the varying altitude of the balloon into account when making the prediction. The path of ground truth 610 was determined using a global positioning system (GPS).

As seen in FIG. 6, predicted path 608 using both the airplane and the NOAA Winds Aloft data had the most accurate prediction of the balloon's landing point 612. The predicted path 608 was determined to be 11.59 miles away from landing point 612, while predicted paths 604 and 606 missed the final destination by 56.08 and 30.24 miles, respectively. Therefore, in implementations, modeling module 120 combines sensor data from moving objects such as aircraft with other information to increase predictive accuracy. Furthermore, in some implementations, the predication module 122 can achieve the same predictive accuracy more efficiently by using a subset of the available aircraft data as discussed in greater detail below.

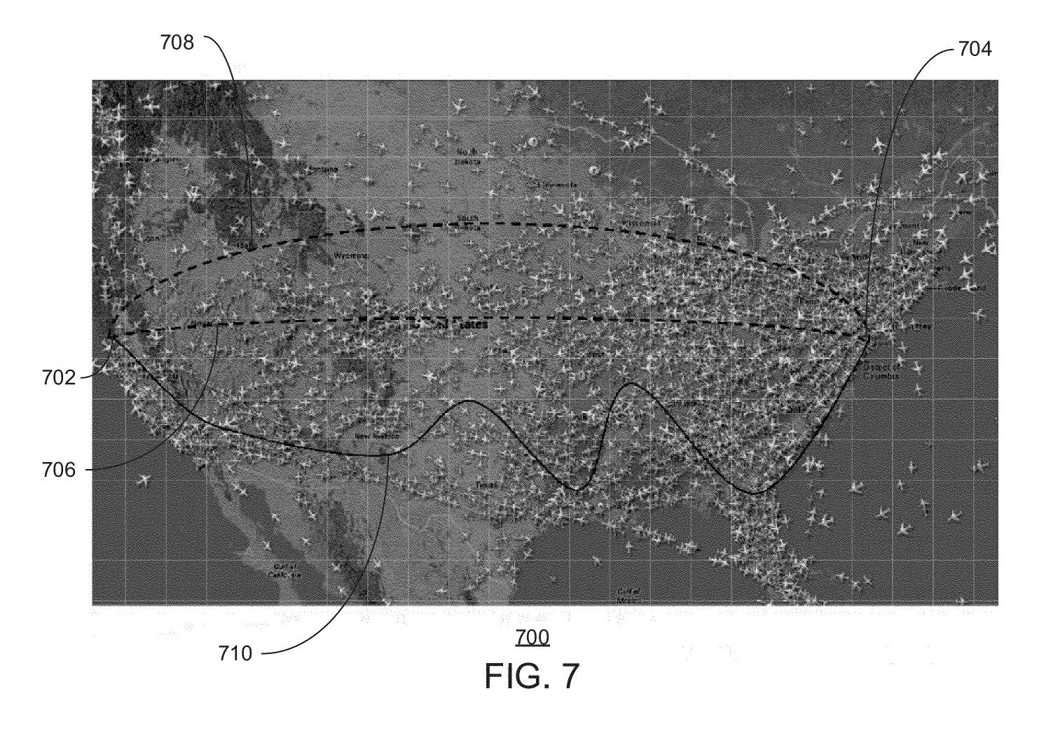

FIG. 7 is a diagram of data from flying aircraft over the continental US with three alternate routes for an aircraft flying from San Francisco (SFO) to Baltimore (BWI). The diagram depicts a departure point 702 in SFO, a destination point 704 in BWI, and three possible routes, 706, 708, 710. Route 706 makes a slight detour towards North. Route 708 is a slightly curved line with minimal detour. Route 710 has three significant changes in direction in the flight path.

In the diagram of FIG. 7, an aircraft has three possible routes from its departure point 702 to its destination point 704. Route 706 is an example traditional direct route that might have been calculated for a nonstop flight. The traditional flight route 706 is based on the assumption that a shortest distance traveled at an optimum speed to reduce drag produces the greatest fuel efficiency. Route 706 is therefore as close to a straight line as possible. A substantial amount of air traffic is also present along route 706. Route 708, in contrast, flies over less crowded skies and thus presents an opportunity to collect otherwise unavailable wind data. In some implementations, the scheduling module 124 may calculate an overall systemic need for data over some routes. For example, the cost of an hour longer flight may be outweighed by the expected VOI gained by taking route 708 as calculated by the optimization module 122. In some implementations, the scheduling module 124 can therefore reroute the aircraft to increase the amount of data, such as wind data, among others, that can be used by the modeling module 120 and the scheduling module 124.

In some implementations, the scheduling module 124 can reroute the aircraft to reduce wind resistance by traveling with the direction of the wind. For example, route 710 is a hypothetical path that might be calculated by scheduling module 124 based on an updated wind map generated by modeling module 120. By flying with the wind, an aircraft flying through route 710 may take less time to reach destination point 704 even though a greater overall distance may have been traveled with reference to the ground.

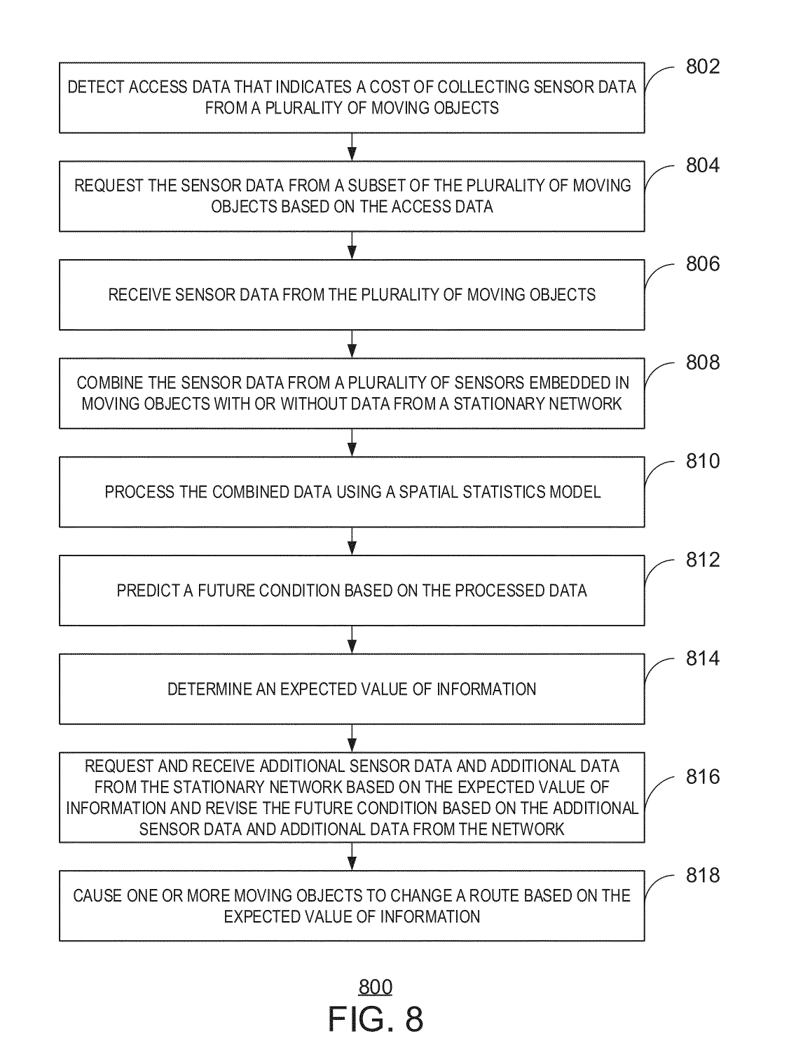

FIG. 8 is a detailed process flow diagram of an example method for processing sensor data from a plurality of moving objects. The method of FIG. 8 is generally referred to by the reference number 800. The method 800 can be implemented by any suitable computing device, such as the computing system 100 of FIG. 1.

At block 802, the modeling module 120 detects access data that indicates a cost of collecting sensor data from a plurality of moving objects. As describe above, the moving objects can be any suitable aircraft, such as a rotorcraft, jet aircraft, propeller aircraft, or drone, among others. The moving objects can also include any suitable watercraft. In some implementations, the data from the plurality of moving objects can be associated with various costs. For example, the cost may be a per request, per sensor cost for accessing the data. In some examples, the cost may be a communications cost of obtaining access to the data from the moving object and/or stationary network. In some examples, the cost can be an analytical cost of processing the extra sensor data.

At block 804, the modeling module 120 requests the sensor data from a subset of the plurality of moving objects based on the access data. In some examples, the modeling module 120 can determine sensor data given a per request, per sensor cost of access to the sensor data. For example, the modeling module 120 could determine that a sensor data that would be redundant due to proximity of location to already received sensor data and therefore not to be requested given the cost for the request as indicated by the access data.

At block 806, the modeling module 120 receives sensor data from the plurality of moving objects. In some examples, the sensor data can be commercially available sensor data. For example, the sensor data can be collected one or more a databases of associated commercial websites. In some examples, the modeling module 120 can access one or more databases to receive the sensor data.

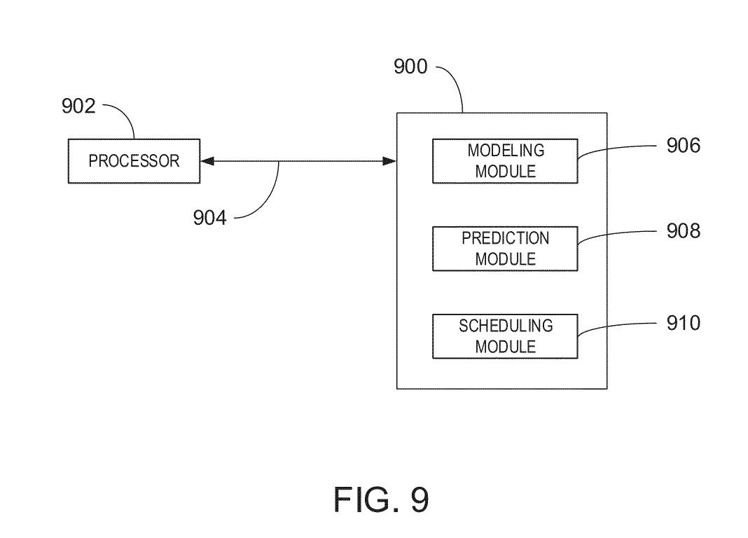

At block 808, the modeling module 120 combines the sensor data from a plurality of sensors embedded in moving objects. In some implementations, the modeling module 120 can also combine the sensor data with data from a stationary network. As discussed above, the stationary network can any suitable support structure or station that collects data from a stationary network at a fixed geographical location. For example, a stationary network may include wind stations, air traffic control systems, and oceanic buoys, among others. In some examples, the sensor data can be combined onto a tangible, computer readable medium, such as the computer readable storage medium 900 of FIG. 9 below, for processing.

At block 810, the modeling module 120 processes the combined data using a spatial statistics model. In some implementations, the spatial statistics model can be a Gaussian process (GP) model. In implementations, the modeling module 120 calculates a kernel function to model the similarity of conditions between sensors at various locations. In some implementations, the modeling model 120 can apply a smoothing constraint to the data as discussed above. For example, the modeling model 120 can apply the smoothing constraint through the use of a GP Prior. In implementations, the modeling module 120 can detect a value for missing information, the value for the missing information calculated by using the spatial statistics model and the combined sensor data from at least one of the plurality of sensors. The missing information can be any type of spatial phenomenon. For example, the missing information could be wind velocity at a given time and location. In some examples, the modeling module 120 infers the missing wind velocity from the sensor data obtained from the wind conditions sensed at wind stations, radar, and aircraft such as airplanes. In implementations, the processed data can be used in a variety of applications. In some implementations, the scheduling module 124 can use the processed data to efficiently route moving objects. For example, the scheduling module 124 can generate a route for a machine to travel. In some implementations, the modeling module 120 can use the processed data to predict turbulence. For example, the modeling module 120 may predict turbulence along a specific route and send that data to the scheduling module 124 that may reroute a moving object to decrease turbulence. In some implementations, the prediction module 122 can use the processed data to decrease travel time for the moving objects. For example, given conditions such as winds, the prediction module 122 can calculate routes for aircraft that take advantage of tail winds to shorten total travel time. In some implementations, the scheduling module 124 can use the processed data to determine a route for the moving objects to travel based on a future condition and/or an expected value of information, wherein the moving objects are controlled via onboard or distributed controls. For example, balloons or gliders may distribute tangible goods or wireless communications, among other things. In some examples, aircraft can be routed based on expected value of information at locations along a route.

At block 812, the prediction module 122 predicts a future condition based on the processed data. As discussed above, a future condition can indicate an environmental condition at any suitable location. For example, a future condition may indicate a projected wind speed, wind direction, or ocean current, among others, for a geographic location. In some implementations, the prediction module 122 can predict a wind velocity at a latitude, longitude, altitude, and time. In some implementations, the prediction can be based on data processed through a spatial statistics model and any information resulting from a joint inference on the combined data. For example, the prediction can also be based on the calculated value for missing information such as in circles 202 and 208 discussed above. In some implementations, the spatial statistics model used can be a Gaussian process model. In some implementations, the processed data can be used to forecast weather conditions. For example, the forecasting of weather conditions can include conditions such as the motion of weather fronts, temperatures, and pressure zones. In some implementations, the processed data to can be used generate a route for air transportation. For example, the air transportation can include a glider that uses wind for powerless flight. In another application, the predictions can be used to understand the flow of one or more balloons, powered or unpowered, for optimizing the positions or distributions of balloons. The processed data can provide wind data to generate a route that utilizes wind for gliding along the route. In some implementations, the processed data can be used to generate a route for ground transportation. For example, a ground vehicle can be provided a route that takes advantage of winds in reducing air resistance over the course of the route. In some implementations, the processed data can be used to generate a route for water transportation. For example, the sensor data can include wind data and water current data. A sailing ship can be provided a route that uses both the wind data and the water current data to lower travel time.

In some implementations, the processed data can be used to detect turbulences and predict future turbulent regions, including frank thundercloud activity and clear-air turbulence. For example, given detected turbulences sensed in different regions, a particular region may inferred to have a high probability of experiencing turbulent conditions. The predicted turbulences could be used for the safety of vehicles by rerouting them around such turbulent regions. In some examples, the predicted turbulences could be used as a warning system that would give notice and time to prepare for the predicted turbulences.

In some implementations, the processed data can be used to control the positioning or configuration of turbines. In some examples, the turbines can be windpower turbines. For example, the processed data can be used to position and/or the windpower turbines such that more power is generated from given wind conditions. In some examples, the turbines can be turbines used in gyre-based power generation. A gyre, as used herein, refers to a system of rotating ocean currents. For example, the processed data can be used to position and/or configure the turbines to increase power produced from the interaction of the turbines with ocean currents.

At block 814, the prediction module 122 determines an expected value of information. As discussed above in block 802, the request and processing of additional sensor data can be associated with various costs. For example, the costs can include the request for and frequency of updating the sensor data. Therefore, in some implementations, an expected value of information (VOI) can be calculated to indicate the benefit of requesting and receiving the information in a cost-benefit analysis. In some implementations, the expected VOI can be based on the amount of information already available for a location and/or a an accuracy of prediction. In some implementations, the expected VOI can be based on the dynamics of conditions of a given location, among other things. Dynamics of conditions, as used herein, refers to the rate of change of conditions in a location. For example, the modeling module 120 may learn about the dynamics of conditions at a location and use the information to determine a higher expected VOI in a location that displays a greater amount of dynamics of conditions. Thus, in a given cost-benefit analysis, a higher cost can be expended in a location expressing more dynamics of conditions and a correspondingly higher expected VOI. In some implementations, the value of information can be modified based on weighting factors. For example, the value of information can be modified based on weighting factors such as current and planned future routes of moving objects over a particular area, priority of moving objects moving over particular routes, and the potential benefits of improved prediction using the additional sensor information for moving objects following those routes. For example, the potential benefits can be a marginal reduction in travel time, energy use and/or turbulence along the current or planned route of the moving object.

At block 816, the prediction module 122 can request and receive additional sensor data and additional data from a stationary network based on the expected value of information and can revise the future condition based on the additional sensor data and additional data from a stationary network. For example, the dynamics of conditions of a location may indicate that additional data is to be requested at regular intervals to keep a model accurate. In some examples, the prediction module 122 can regularly request information from locations that the modeling module 120 indicates have higher dynamics of conditions. In some examples, the prediction module 122 can request information from sensor data along the route of a given plan. For example, airplanes or wind stations along a route may be queried for current wind conditions.

At block 818, the scheduling module 124 can cause one or more moving objects to change a route based on the expected value of information. For example, the scheduling module 124 can cause one or more aircraft to change a flight plan based on the expected value of information. In some implementations, the expected value of information in a location may outweigh a cost associated with moving the subset of moving objects to the location. For example, an airplane can be rerouted from its original flight path in order to provide sensor information for wind conditions along a different route containing locations in which sensor data would have a higher expected value of information. In some examples, the airplane operator may be compensated for the sensor information. The scheduling module 124 can then use this additional information in routing other moving objects more efficiently. In some examples, this additional information can result in better and real-time estimation of spatial phenomenon in general.

The process flow diagram of FIG. 8 is not intended to indicate that the operations of the method 800 are to be executed in any particular order, or that all of the operations of the method 800 are to be included in every case. For example, the prediction module 122 can request additional information 816 after the scheduling module 124 causes one or more aircraft to change a flight plan 818. The prediction module 122 can also determine an expected value of information 814 after the scheduling module 124 has caused one or more aircraft to change a flight plan 818. Further, any number of additional operations can be included within the method 800, depending on the specific application.

FIG. 9 is a block diagram showing a tangible, computer-readable storage medium for analysis of sensor data. The tangible, computer-readable storage media 900 may be accessed by a processor 902 over a computer bus 904. Furthermore, the tangible, computer-readable storage media 900 may include code to direct the processor 902 to perform the current method.

The various software components discussed herein may be stored on the tangible, computer-readable storage media 900, as indicated in FIG. 9. For example, the tangible computer-readable storage media 900 can include a modeling module 906, a prediction module 908, and a scheduling module 910. In implementations, the modeling module includes a plurality of instructions that, when executed by a processor, cause the processor to receive sensor data from a plurality of moving objects and data from a stationary network. For example, the stationary network can be composed of wind stations. In implementations, the prediction module 908 detects access data that indicates the cost of collecting sensor data from the plurality of moving objects. For example, collecting sensor data may cost a set amount per request. The prediction module 908 also detects a threshold value for the access data. In some examples, the threshold value can be based in part on a value of information of the moving object data. In implementations, the modeling module 906 requests the sensor data from a subset of the plurality of moving objects based on the access data.

In implementations, the modeling module 906 combines the sensor data with data from a stationary network. In implementations, the modeling module 906 processes the combined data using a spatial statistics model. For example, the modeling module 906 can apply a smoothing constraint to the data and/or process the combined data using a GP model. In some implementations, the modeling module 906 can apply a noise model to the data. For example, the modeling module 906 may apply a model that minimizes the effects of turbulence on sensor data.

Still referring to FIG. 9, in implementations, the prediction module 908 can then predict a future condition based on the processed data. For example, the wind velocity in a given location and time can be predicted. In some implementations, the prediction module 908 can include instructions to calculate an expected value of information based at least in part on dynamics of conditions. In some examples, the modeling module 906 can share information about the dynamics of conditions of a location and the prediction module 908 can request updated sensor data at a rate based on how much dynamics of conditions is displayed at the given location. For example, a route with more dynamics of conditions may have more updates in order to maintain a level of accuracy. In some implementations, the prediction module 908 can request additional sensor data based on a threshold value that indicates a budget for collecting the sensor data.

It is to be understood that any number of additional software components not shown in FIG. 9 can be included within the tangible, computer-readable storage media 900, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### Example 1

An example of a system is provided. The example system includes a processor to execute processor executable code. The processor executable code, when executed by the processor, causes the processor to combine sensor data from a plurality of sensors embedded in moving objects. The code also causes the processor to process the combined data using a spatial statistics model. The code also causes the processor to predict a future condition based on the processed data.

In some implementations, the combined data can include data from a stationary network. The spatial statistics model can be a Gaussian process model. The stationary network can include a plurality of wind sensors and/or water current sensors. The moving objects can include a plurality of aircraft. The sensor data can include groundspeeds and airspeeds of the aircraft. Processing the combined data can include detecting a value for missing data, the value for the missing data calculated by using the spatial statistics model and the sensor data from at least one of the plurality of sensors. In some implementations, the example system can include processor executable code that, when executed by the processor, causes the processor to calculate an expected value of information. In some implementations, the example system can include code that causes the processor to request and receive additional sensor data based on the expected value of information and to revise the future condition based on the additional sensor data. In some implementations, the example system can include code that causes the processor to cause one or more aircraft to change a flight plan based on the expected value of information.

### Example 2

An example of a method is provided. The example method includes receiving the sensor data from the plurality of moving objects. The example method also includes combining the sensor data. The example method includes processing the combined data using a spatial statistics model. Processing the combined data includes calculating a value for missing information based on the combined data.

In some implementations, the combined data can include data from a stationary network. The spatial statistics model can be a Gaussian process model. The stationary network can include a plurality of wind sensors and/or water current sensors. The example method can also include predicting a future condition based on the combined data and the value for the missing information. In some implementations, the example method can include determining an expected value of information that indicates a frequency at which sensor data is to be collected. In some implementations, the example method can also include requesting additional sensor data from a location based on the frequency indicated by the expected value of information. In some implementations, the example method can include determining an expected value of information based on weighting factors. The example method can also include moving a subset of the plurality of moving objects based on the expected value of information. The weighting factors can include current and future scheduled routes, priority of the moving objects, and potential benefits from improved prediction.

The example method can include using the processed data to generate a route for air transportation. The air transportation can include a glider or balloon that uses wind for flight. The predictions can also be used to predict and guide the motion of balloons over time. In some implementations, the example method can include using the processed data to generate a route for ground transportation. In some implementations, the example method can include using the processed data to generate a route for water transportation. The sensor data can include wind data and water current data. In some implementations, the example method can include using the processed data to detect turbulence and predict future turbulent regions. In some implementations, the example method can include using the processed data to control the positioning or configuration of turbines. The turbines can include windpower turbines and/or turbines used in gyre-based power generation. In some implementations, the example method can include using the processed data to forecast weather conditions. In some implementations, the example method can include using the processed data to decrease travel time for the moving objects. In some implementations, the example method can include using the processed data to determine a route for the moving objects to travel based on a future condition and an expected value of information, wherein the moving objects are controlled via onboard or distributed controls.

### Example 3

An example of a computer-readable memory storage device is provided. The example computer-readable storage media include instructions that, when executed by a processor, cause the processor to detect access data that indicates a cost of collecting sensor data from a plurality of moving objects. The example computer-readable storage media also include instructions that cause the processor to request the sensor data from a subset of the plurality of moving objects based on the access data. The example computer-readable storage media also include instructions that cause the processor to combine the sensor data with data from a stationary network. The example computer-readable storage media also include instructions that cause the processor to process the combined data using a spatial statistics model. The example computer-readable storage media also include instructions that cause the processor to predict a future condition based on the processed data.

In some implementations, the spatial statistics model can be a Gaussian process model. The stationary network can include a plurality of wind sensors and/or water current sensors. The example computer-readable storage media can include instructions that cause the processor to request additional sensor data based on a threshold value that indicates a budget for collecting the sensor data. In some implementations, the example computer-readable storage media can include instructions that cause the processor to calculate an expected value of information based at least in part on dynamics of conditions.

### Example 4

An example of a system is provided. The example system includes a means for executing processor executable code. The example system further includes a means for combining sensor data from a plurality of sensors embedded in moving objects. The example system also includes a means for processing the combined data. The example system also includes a means for predicting a future condition based on the processed data.

In some implementations, the combined data can also include data from a stationary network. The stationary network can include a plurality of wind sensors and/or water current sensors. The example system can include a means for calculating an expected value of information. In some implementations, the example system can include means for requesting and receiving additional sensor data based on the expected value of information and means for revising the future condition based on the additional sensor data. In some implementations, the example system can include means for causing one or more aircraft to change a flight plan based on the expected value of information.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for prediction, comprising a processor to execute processor executable code, wherein the processor executable code, when executed by the processor, causes the processor to:
combine sensor data from a plurality of sensors embedded in moving objects;
process the combined data using a spatial statistics model; and
predict a future condition based on the processed data.

2. The system of claim 1, the combined data further comprising data from a stationary network.

3. The system of claim 2, wherein the stationary network comprises a plurality of wind sensors and/or water current sensors.

4. The system of claim 1, wherein the spatial statistics model comprises a Gaussian process model.

5. The system of claim 1, wherein the moving objects comprise a plurality of aircraft and the sensor data comprises groundspeeds and airspeeds of the aircraft.

6. The system of claim 1, wherein processing the combined data comprises detecting a value for missing data, the value for the missing data calculated by using the spatial statistics model and the sensor data from at least one of the plurality of sensors.

7. The system of claim 1, further comprising processor-executable code, wherein the processor-executable code, when executed by the processor, causes the processor to calculate an expected value of information.

8. The system of claim 7, further comprising processor-executable code, wherein the processor-executable code, when executed by the processor, causes the processor to request and receive additional sensor data based on the expected value of information and to revise the future condition based on the additional sensor data.

9. The system of claim 7, further comprising processor-executable code, wherein the processor executable-code, when executed by the processor, causes the processor to cause one or more aircraft to change a flight plan based on the expected value of information.

10. A method for processing sensor data from a plurality of moving objects, comprising:
receiving the sensor data from the plurality of moving objects;
combining the sensor data; and
processing the combined data using a spatial statistics model, including calculating a value for missing information based on the combined data.

11. The method of claim 10, the combined data further comprising data from a stationary network.

12. The method of claim 11, wherein the stationary network comprises a plurality of wind sensors and/or water current sensors.

13. The method of claim 10, further comprising predicting a future condition based on the combined data and the value for the missing information.

14. The method of claim 13, further comprising:
determining an expected value of information that indicates a frequency at which sensor data is to be collected; and
requesting additional sensor data from a location based on the frequency indicated by the expected value of information.

15. The method of claim 13, further comprising determining an expected value of information based on weighting factors and moving a subset of the plurality of moving objects based on the expected value of information, the weighting factors comprising current and future scheduled routes, priority of the moving objects, and potential benefits from improved prediction.

16. The method of claim 10, comprising using the processed data to generate a route for air transportation.

17. The method of claim 16, the air transportation comprising a glider or balloon that uses wind for flight.

18. The method of claim 10, comprising using the processed data to generate a route for ground transportation.

19. The method of claim 10, comprising using the processed data to generate a route for water transportation, the sensor data comprising wind data and water current data.

20. The method of claim 10, comprising using the processed data to detect turbulence and predict future turbulent regions.

21. The method of claim 10, comprising using the processed data to control the positioning or configuration of turbines, the turbines comprising windpower turbines and/or turbines used in gyre-based power generation.

22. The method of claim 10, comprising using the processed data to forecast weather conditions.

23. The method of claim 10, comprising using the processed data to determine a route for the moving objects to travel based on a future condition and an expected value of information, wherein the moving objects are controlled via onboard or distributed controls.

24. One or more computer-readable storage media for analysis of sensor data, comprising a plurality of instructions that, when executed by a processor, cause the processor to:
detect access data that indicates a cost of collecting sensor data from a plurality of moving objects;
request the sensor data from a subset of the plurality of moving objects based on the access data;
combine the sensor data with data from a stationary network;
process the combined data using a spatial statistics model; and
predict a future condition based on the processed data.

25. The one or more computer-readable storage media of claim 24, wherein the stationary network comprises a plurality of wind sensors and/or water current sensors.
